(19) United States
(12) Patent Application Publication
(10) Pub. No.: US 2019/0313653 A1
(43) Pub. Date: Oct. 17, 2019

(54) BEAN-BASED FLOUR

(71) Applicants: The United States of America, as represented by the Secretary of Agriculture, Washington, DC (US); Board of Trustees of Michigan State University, East Lansing, MI (US)

(72) Inventors: KAREN A. CICHY, OKEMOS, MI (US); SHARON D. HOOPER, EAST LANSING, MI (US)

(21) Appl. No.: 16/374,122

(22) Filed: Apr. 3, 2019

Related U.S. Application Data
(60) Provisional application No. 62/656,563, filed on Apr. 12, 2018.

(51) Int. Cl. A21D 13/045; A23L 11/00; A23L 5/10; A23L 5/30; A23P 10/40

(52) U.S. Cl. CPC A21D 13/045; A23L 11/05; A23L 5/10; A23L 5/30; A23V 2300/24; A23V 2002/00; A23V 2300/31; A23V 2300/10; A23P 10/40

(57) ABSTRACT

The bean-based flour is produced by heat treating dry beans and then milling the beans in a pressure interference wave mill. Pastas made with the resulting bean-based flour have a taste that is demonstrably superior to pastas that are made with beans milled by conventional means.

### REFERENCE TO RELATED APPLICATIONS

This application claims the benefit of U.S. Provisional Application No. 62/656,563, filed Apr. 12, 2018, which is incorporated herein by reference in its entirety.

### FIELD OF THE INVENTION

The disclosed product and process relates to a method for making dry bean flour. Specifically, the product and process relate to a new bean-based flour that includes the use of a pressure interference wave mill. The new flour has characteristics that are clearly distinguishable from current bean-based flours.

### BACKGROUND OF THE INVENTION

The relationship between food and health has an increasing impact on food innovation. Dry beans are a natural resource of key dietary nutrients such as protein and iron, which are important dietary components—particularly for children, adolescents, and the elderly. Dry beans are also an economical source of complex carbohydrates, and dietary fiber (both soluble and insoluble) as well as several vitamins and minerals. However, the extended time required to prepare many conventional bean dishes is a major drawback that limits consumption.

To address this problem, the inventors investigated the use of bean products (such as flour) as a supplement or a replacement for some wheat-based products, such as pastas. Approximately 84% of US households consume (primarily) wheat-based pasta weekly, due to pasta's versality, convenience, and ease of preparation. However, pastas made with dried bean-based flour have more nutritional value than wheat-based pastas—and dry beans are also gluten free. Approximately 1% of North Americans suffer from gluten intolerance. The demand for gluten-free foods is expected to grow annually by a rate of 6% over the next four to five years.

The chemical compounds commonly found in beans such as polyphenols and fatty acids can affect the taste and limit the use of bean-based flour as an ingredient. Specifically, during the milling process, these compounds can be oxidized and consequently impart a “beany” flavor to bean-based flours. The “beany” flavor is considered to be undesirable by most consumers, and severely limits the amount of bean-based flour that can be used in many food products (including pastas).

However, the inventors have found that, by using a pre-treatment protocol, in combination with the use of a recently-developed bean milling process, the resulting bean flour product unexpectedly/surprisingly does not exhibit the “beany” undesirable taste present in bean-based flours milled using conventional processes. Using the process described herein, the inventors can produce (for example) bean-based pastas with a quality comparable to wheat-based pastas. Further, the bean-based pasta products are gluten free and have more nutritional value than similar wheat-based pastas.

### SUMMARY OF THE INVENTION

This disclosure is directed to a process of pretreating and milling dry beans into a bean-based flour. In accordance with the process described herein, the beans are pre-heated (i.e. “heat treated”) for approximately one hour and 10 minutes, and then milled into flour using a pressure interference wave mill. Pastas made by this process have a surprising/unexpected taste that is superior to the taste of bean-based pastas made by prior art processes.

### BRIEF DESCRIPTION OF THE DRAWINGS

FIG. 1 is a photograph of a pressure interference wave mill used to produce the bean-based flour described herein. Specifically, FIG. 1 shows an ENAGON Model 221 Power Wave Mill used to process the bean-based flour described in the preferred embodiment.

FIG. 2 is a partial sectional elevational schematic view of a pressure interference wave mill. The processing chamber of the mill is shown as a sectional view.

### DETAILED DESCRIPTION OF PREFERRED EMBODIMENTS

The bean-based flour described herein is produced by heat treating dry beans and then using a pressure interference wave mill to produce a bean-based flour. In accordance with the heat treating process, dry beans are spread in single layers on dryer racks and heated/roasted for about one hour and 10 minutes at 110° C. The treated beans are then allowed to cool.

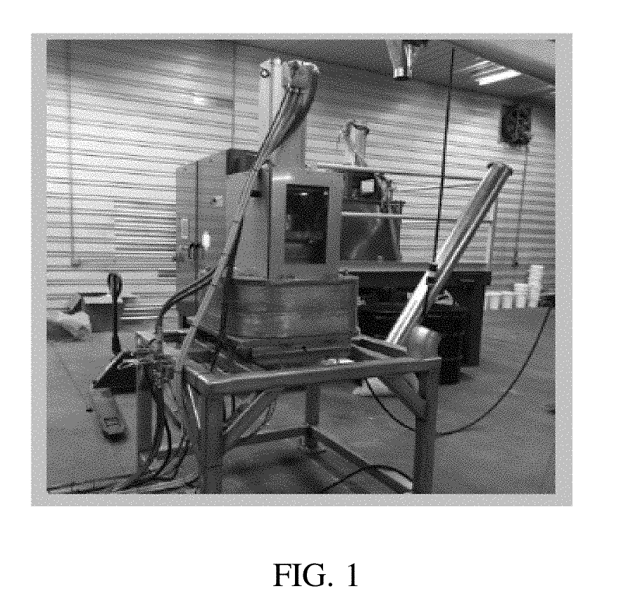

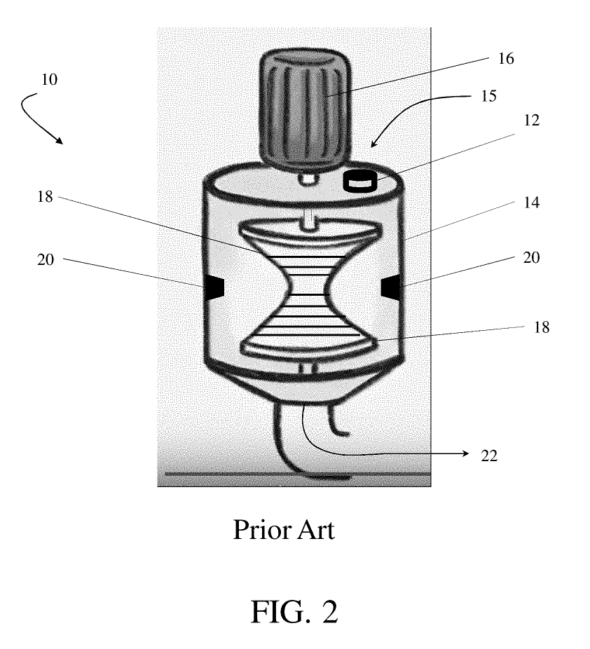

The treated dried beans are then milled in a “pressure interference wave mill”. In the preferred embodiment, the beans are milled by an ENAGON Model 221 Power Wave Mill (as shown in FIG. 1). FIG. 2 is a schematic of one embodiment of the mill. This type of mill may be known as a “soundwave mill” or a “power wave mill”, or by other names suggesting sound/pressure waves. One embodiment of a pressure interference wave mill is described in US Patent Application Publication US2017/0252751 to Ebels et al., which is hereby incorporated by reference in its entirety. Pressure interference wave mills are sold (at least) by ENAGON LLC and described as “power wave mills”. These mills include ENAGON models 130, 221, 230, 308, 421, 621, and customized variants.

For the purposes of this disclosure, a “pressure interference wave mill” is defined as a mill that produces sound waves, pressure waves and/or shock waves that are tuned to remove moisture molecules while milling an input material. Specifically, the sound waves, pressure waves and/or shock waves (generated by (for example) multiple frequency turbine plates and boundary plates) interact with each other and the material fed into the mill to process (i.e. powderize) the material—so that the soundwaves, pressure waves and/or shock waves comprise the force elements that powderize the material in the pressure interference wave mill. Essentially, the material processed by a pressure interference wave mill is not powderized into a final product through a conventional mechanical grinding/abrading means. Consequently, a pressure interference mill is clearly distinguishable from a conventional mill/milling process. For the purposes of this disclosure, a “conventional mill/milling process” is defined as a hammer mill, ball mill, roller mill, grist mill, knife mill, etc.—and any other type of mill that works through conventional mechanical cutting, grinding, or abrading processes.

As shown in FIG. 2, in one exemplary embodiment of the current process, input material is fed into the top inlet 12 of a cylindrical processing chamber 14 in the direction of the arrow 15. A powerful direct drive motor 16 drives a precision-designed high-speed turbine assembly 18 (which may rotate faster than the speed of sound) within the chamber 14. The turbine assembly 18 creates air flow and sound waves that impinge off specially designed baffles 20 around the periphery of the processing chamber 14. Pressure in the processing chamber 14 may exceed 2800 psi. The pressure—in combination with the sound and shock waves also created by the turbine assembly—pulverizes most milled material down to about 10 microns—although smaller particles are possible with repeated passes. Processed material moves vertically downwardly through the processing chamber 14 and out the bottom of the chamber in the direction of the arrow 22, where it is then circulated to other machinery for packaging or any post-milling processes.

In accordance with the claimed invention, after heat treating as described above, the dry beans are milled down to about 100 microns and a 4% moisture content. Further, bean flours processed as described are generally more “flowable” and can be more easily used in commercial manufacturing process without sticking to processing equipment. As noted above, bean flours produced according to the described process surprisingly do not exhibit a “beany” taste, and pastas cooked by the process are essentially indistinguishable from wheat-based pastas.

Nutritional and Moisture Content Comparison of Bean Flours Generated by the Comitrol Knife and Sonic Wave Mills

As discussed above, the functional properties of bean flours are critical to the quality characteristics of the final food product. Pretreatment and milling technique can significantly affect the functional properties of flours generated including water absorption, particle size distribution, starch gelatinization protein content and solubility, and shelf life

A nutritional profile of heat-treated untreated heat-treated whole bean flours is shown in Table 1. The “Zenith” beans referenced in Table 1 refer to a variety of black beans, and the “Medalist” beans refer to a variety of navy beans. Although black beans and navy beans were used, the results are generally consistent with other types of beans. As noted in the legend below Table 1, the “U” designation means that the beans were not heat treated (i.e. the beans were “untreated”), and the “T” designation means that the beans were heat treated. The knife milling process was used for the Table 1 comparison because knife milling is currently the industry recommended method for milling beans.

Significantly, bean flours produced via the sound wave mill (e.g. Medalist U, 4.3%) had a lower percentage moisture in comparison to those produced using the knife mill (e.g. Medalist U,10.9%) Similarly, the moisture content of treated flours (e.g. Zenith T, 6.0%) were significantly lower when compared to their untreated (Zenith U, 9.8%) counterparts. A low moisture content can prolong the shelf life of flours by reducing microbial spoilage and lipid oxidation which cause the deterioration of foods (Kulchan, Boonsupthip, & Suppakul, 2010; Nicoli, 2012).

The protein concentrations of knife milled flours for both bean varieties were significantly greater than those produced using the sound wave milling method when collected from the cyclone zone (19.2-20.4 vs 12.4-14.3), while the reverse was noted for total carbohydrates (62.9-67.3 vs 75.8-78.9). This finding was unexpected, and the disparity was due to the flour collection zone used for the sound wave mill, where only fractions from the cyclone zone were collected. This is further clarified in Table 2 where bean flour samples were collected from both the cyclone and baghouse zones. In general, the ash content of the knife milled flours was higher than the sound wave milled flours (Table 1). A taste test of the bean flours produced during the research indicated that the least “beany” tasting flours were those flours milled with the pressure interference wave mill that exhibited relatively low protein content and were collected from the cyclone processing zone.

TABLE 1
Nutritional profile of treated and untreated bean flours generated from a knife mill and
the cyclone zone of the sound wave mill.¹

| | | | | | | | | | Starch |
|---|---|---|---|---|---|---|---|---|---|
| Bean | | | Cal. | Fat | Carbohydrate | Protein | Ash | Moisture | Damage |
| Flour | Mill | Trt | (kcal) | (%) | (%) | (%) | (%) | (%) | (%) |
| Medalist | SW² | U⁴ | 382 a | 2.0 c,d | 78.2 a | 13.1 b | 2.7 d | 4.3 e | 1.0 a |
| Medalist | SW | T⁵ | 381 a | 1.8 c, d | 78.9 a | 12.4 b | 3.0 c, d | 4.1 f | 0.9 a |
| Medalist | KN³ | U | 355 e | 2.8 a | 62.9 b | 19.9 a | 3.7 a, b, c | 10.9 a | 0.6 b, c |
| Medalist | KN | T | 364 d | 2.4 a, b | 65.4 b | 20.4 a | 4.4 a | 7.6 c | 0.5 c, d |
| Zenith | SW | U | 375 b | 1.7 d | 75.8 a | 14.3 b | 3.2 c, d | 5.2 e | 0.7 b |
| Zenith | SW | T | 382 a | 2.2 b, c | 76.5 a | 14.1 b | 3.2 b, c, d | 4.1 f | 0.6 b, c |
| Zenith | KN | U | 355 e | 2.1 b, c, d | 65.1 b | 19.2 a | 3.9 a, b | 9.8 b | 0.6 b, c |
| Zenith | KN | T | 371 c | 2.3 a, b, c | 67.3 b | 20.4 a | 4.2 a | 6.0 d | 0.4 d |

¹Values are means of duplicate replicates. Means sharing the same letter in each column are not significantly different at P ≤ 0.05.
²Where SW is sound wave mill and flours were collected from the cyclone zone,
³KN is knife mill,
⁴U is untreated,
⁵T is Heat Treated.

However, further investigations showed that the sound wave mill can produce bean flours with variable protein concentrations, approximately 12.7 to 35.6% (Table 2). Bean flours collected from the baghouse had high protein contents ranging from 33.6% to 35.6% which the knife mill is unable to produce without further fractionation. Bean flours generated from the different zones (cyclone and baghouse) of the soundwave mill can be used as single zone collection bean flours or combined collection zone bean flours and used in various food applications based on protein concentration. The starch damage for all the flours ranged from 0.4-1.0%, with untreated and treated, sound wave milled Medalist flours yielding the highest values (1.0%, 0.9%). Starch damage occurs when starch granules are broken usually during the milling process and can impact water absorption and dough mixing properties, thus affecting the quality of the end use product (Hager, Wolter, Jacob, Zannini, & Arendt, 2012; Mancebo, Picón, & Gómez, 2015). A high level of starch damage in flours would produce a sticky dough. The level of starch damage in hard wheat is 6-12%, while soft wheat is 2-4% (Tester, 1997).

TABLE 2
Protein Content of Bean Flours Collected from the Cyclone and
Baghouse of Enagon's Sonic Mill¹

| | Heat | | | |
|---|---|---|---|---|
| Sample | Treatment | Pass | Collection | % Protein |
| Medalist | Yes | 1 | Cyclone | 17.8 |
| Medalist | Yes | 2 | Cyclone | 12.7 |
| Medalist | Yes | 1 | Baghouse | 35.6 |
| Medalist | Yes | 2 | Baghouse | 33.6 |
| Medalist | No | 2 | Cyclone | 14.9 |

¹Values are means of two replicates.

### REFERENCES CITED IN NUTRITIONAL AND MOISTURE COMPARISON SECTION

Hager, A.-S., Wolter, A., Jacob, F., Zannini, E., & Arendt, E. K. (2012). Nutritional properties and ultra-structure of commercial gluten free flours from different botanical sources compared to wheat flours. Journal of Cereal Science, 56(2), 239-247.
Kulchan, R., Boonsupthip, W., & Suppakul, P. (2010). Shelf life prediction of packaged cassava-flour-based baked product by using empirical models and activation energy for water vapor permeability of polyolefin films. Journal of Food Engineering, 100(3), 461-467.
Mancebo, C. M., Picón, J., & Gomez, M. (2015). Effect of flour properties on the quality characteristics of gluten free sugar-snap cookies. LWT—Food Science and Technology, 64(1), 264-269. https://doi.org/10.1016/J.LWT.2015.05.057
Nicoli, M. (2012). Shelf Life Assessment of Food (Vol. 20122242). CRC Press.
Tester, R. (1997). Properties of damaged starch granules: composition and swelling properties of maize, rice, pea and potato starch fractions in water at various temperatures. Food Hydrocolloids.

For the foregoing reasons, it is clear that the method described herein provides an innovative method of making a bean-based flour. As noted above, in the preferred embodiment, the flour is used to make pasta, however other food products should be considered within the scope of the invention.

The amounts, percentages and ranges disclosed herein are not meant to be limiting, and increments between the recited amounts, percentages and ranges are specifically envisioned as part of the invention. All ranges and parameters disclosed herein are understood to encompass any and all sub-ranges subsumed therein, and every number between the endpoints. For example, a stated range of “1 to 10” should be considered to include any and all sub-ranges between (and inclusive of) the minimum value of 1 and the maximum value of 10 including all integer values and decimal values; that is, all sub-ranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. Similarly, if the term “about” precedes a numerically quantifiable measurement, that measurement is assumed to vary by as much as 10%. Essentially, as used herein, the term “about” refers to a quantity, level, value, or amount that varies by as much 10% to a reference quantity, level, value, or amount.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein). The invention illustratively disclosed herein suitably may be practiced in the absence of any element which is not specifically disclosed herein.

What is claimed is:

1. A method of making a bean-based flour comprising the steps of:
(a) providing dry beans;
(b) roasting the dry beans for about 40-100 minutes at 80-140° C.; and,
(c) milling the beans with a pressure interference wave mill.

2. The method of claim 1, wherein, in step (b) the beans are spread in single layers in during roasting.

3. The method of claim 1, wherein, in step (b) the beans are roasted in an atmosphere of less than 70% humidity.

4. The method of claim 1 wherein the flour is used to create a pasta as a final product.

5. The method of claim 4 wherein the pasta final product has a taste and texture that is essentially indistinguishable from wheat-based pasta.

6. The method of claim 1 wherein, in step (a), the beans are selected from a group consisting of at least Alpena-navy, Samurai-otebo, Snowdon-white kidney, Etna-cranberry, Redhawk-dark red kidney, Zenith-black, or combinations thereof.

7. The method of claim 1 wherein the bean-based flour has a lower moisture content than the flour produced with the same type of beans by a conventional mill/milling process.

8. The method of claim 1 wherein protein content of the bean-based flour is substantially different from the protein content exhibited by the bean-based flour from the same bean types when those beans are milled using a conventional mill/milling process.

9. The method of claim 1 wherein protein content and the ash content of the bean-based flour collected from the cyclone bean processing zone during flour processing, is lower than the protein and ash content from the same bean types collected from the cyclone zone when those beans are milled using a conventional mill/milling process.

10. The method of claim 1 wherein bean flour collected from the cyclone bean processing zone has a less beany taste than the same bean types collected from the cyclone zone when those bean types are milled using a conventional mill/milling process.

11. The method of claim 1 wherein, in step (b), the beans are roasted for about 1 hour 10 minutes at 110° C.

12. A bean-based flour product produced by the process of milling dried beans with a pressure interference wave mill.

13. The bean-based flour of claim 12 wherein the beans are heat treated for 40-100 minutes at 80-140° C. before they are milled.

14. The bean-based flour product of claim 12 wherein the product has a lower moisture content than the same type of beans by a conventional mill/milling process.

15. The bean-based flour product of claim 12 wherein the product bean flour with the least beany taste is collected from the cyclone processing zone.
